(19) United States
(12) Patent Application Publication
(10) Pub. No.: US 2009/0114863 A1
(43) Pub. Date: May 7, 2009

(54) Electromagnetically driven valve

(76) Inventor: Hideyuki Nishida, Shizuoka-ken (JP)

Correspondence Address: KENYON & KENYON LLP, 1500 K STREET N.W., SUITE 700, WASHINGTON, DC, 20005, US

(21) Appl. No.: 10/583,989

(22) PCT Filed: Aug. 4, 2005
(86) PCT No.: PCT/IB05/02828

§ 371 Date: Jun. 22, 2006

(30) Foreign Application Priority Data
Aug. 19, 2004 (JP) 2004-239776

(51) Int. Cl. F16K 31/02

(52) U.S. Cl. 251/129.15; 123/90.11

(57) ABSTRACT

An electromagnetically driven valve includes a drive valve with a stem; a lower disk and an upper disk, each of which can oscillate by using a predetermined point in a disk base as a supporting point, each of which is movably connected to the stem at a first end and is movably supported by the disk base at a second end, and which are provided at a predetermined distance from each other; an electromagnet includes an open/close coil provided between the lower and upper disks; and a detector coil which detects a position of at least one of the drive valve, the lower disk, and the upper disk. The electromagnetic force is applied to the lower and upper disks when an electric current passes through the open/close coil. An amount of electric current that passes through the open/close coil is determined based on the position of the drive valve.

### BACKGROUND OF THE INVENTION

1. Field of the Invention

The invention relates to an electromagnetically driven valve. More specifically, the invention relates to a rotary drive type electromagnetically driven valve used for an internal combustion engine.

2. Description of the Related Art

Conventional types of electromagnetically driven valves are disclosed in, for example, Japanese Patent Application Publication No. 2000-130123 A, and Japanese Patent Application Publication No. 2000-130124 A. Also, a displacement detecting device for a movable body is disclosed in Japanese Utility Model Application Publication No. 63-126817.

Japanese Patent Application Publication No. 2000-130123 discloses a technology in which a ring type sensor is provided around a taper portion of an armature shaft, a moving speed and a position of an armature are detected, and feed back control is performed.

Japanese Patent Application Publication. No. 2000-130124 discloses a displacement sensor which detects a displacement of a drive shaft of an electromagnetic actuator, and a structure in which an eddy current displacement sensor is attached to a support member of the drive shaft.

Japanese Utility Model Application Publication No. 63-126817 discloses a technology in which a taper surface is formed in a surface that is used for detecting a displacement.

In a conventional technological field concerning an electromagnetically driven valve, there is a problem that, if a detection portion for measuring a displacement of an electromagnetically driven valve is provided, the size of the electromagnetically driven valve is increased due to the provision of this detection portion.

### SUMMARY OF THE INVENTION

The invention is made in order to solve the above-mentioned problem. It is, therefore, an object of the invention to provide a compact electromagnetically driven valve.

According to an aspect of the invention, there is provided an electromagnetically driven valve which includes a drive valve that is provided with a valve stem and that reciprocates in a direction in which the valve stem extends, and which operates by using both an electromagnetic force and an elastic force. The electromagnetically driven valve further includes a first oscillating member and a second oscillating member each of which can oscillate by using a predetermined point in a base member as a supporting point, each of which is movably connected to the valve stem at a first end and is movably supported by the base member at a second end, and which are provided at a predetermined distance from each other, an electromagnet which includes a coil, and which is provided between the first oscillating member and the second oscillating member, and a detection portion which detects a position of at least one of the drive valve, the first oscillating member, and the second oscillating member, wherein the electromagnetic force is applied to the first oscillating member and the second oscillating member when an electric current passes through the coil, and an amount of electric current that passes through the coil is determined based on the position detected by the detection portion.

In the thus configured electromagnetically driven valve, there is provided the detection portion which detects the position of at least one of the drive valve, the first oscillating member, and the second oscillating member. Therefore, the size of this electromagnetically driven valve can be made smaller than that of a conventional type of electromagnetically driven valve in which a drive valve and an electromagnet are provided in series and a position of the drive valve is detected.

In the first aspect, a cross sectional area of a portion in the drive valve may continuously change, and the detection portion may detect the position of the drive valve based on the position in the portion whose cross sectional area continuously changes. In this case, since the detection portion detects the position in the portion whose cross sectional area continuously changes, the position of the drive valve can be more accurately detected by the detection portion.

Further, a cross section of the portion in the drive valve, whose cross sectional area continuously changes, may be rectangular, and the cross sectional area may change linearly in the axial direction of the valve stem. Alternatively, a cross section of the portion in the drive valve, whose cross sectional area continuously changes, may be circular, and the cross sectional area may change linearly in the axial direction of the valve stem.

The detection portion may detect a deviation of the drive valve from a reference axis. Paired detection portions are provided with the valve stem interposed therebetween in the direction perpendicular to the axial direction of the valve stem. The detection portion calculates the deviation of the drive valve, thereby detecting the deviation of the drive valve. A reciprocating movement of the drive valve can be corrected based on the detected deviation.

The detection portion may be provided at an upper end portion of the drive valve.

The detection portion may be provided in the base member so as to face at least one of the first oscillating member and the second oscillating member. With such an arrangement of the detection portion, the position of the drive valve after displacement can be detected by calculating an oscillation angle of at least one of the first oscillating member and the second oscillating member.

If the direction in which the electric current passes through the coil is reversed in a state where one of the first oscillating member and the second oscillating member has been attracted to the electromagnet, an electromagnetic force is applied to the one of the first oscillating member and the second oscillating member, which has been attracted to the electromagnet, in a direction in which the one of the first oscillating member and the second oscillating member moves away from the electromagnet.

With the above-mentioned structure, it is possible to provide a compact electromagnetically driven valve.

### BRIEF DESCRIPTION OF THE DRAWINGS

The features, advantages thereof, technical and industrial significance of this invention will be better understood by reading the following detailed description of preferred embodiments of the invention, when considered in connection with the accompanying drawings, in which:

FIG. 1 illustrates a cross sectional view of an electromagnetically driven valve according to a first embodiment of the invention;

FIG. 2 illustrates a concrete perspective view of a stem of the electromagnetically driven valve;

FIG. 3 illustrates a graph describing a relationship between a length and a thickness of a taper portion of the stem;

FIG. 4 illustrates a side view describing an angle formed by an upper disk of the electromagnetically driven valve;

FIG. 5 illustrates a perspective view of a lower disk (upper disk) in FIG. 1;

FIG. 6 illustrates a perspective view of an electromagnet in FIG. 1;

FIG. 7 schematically illustrates the upper disk and the lower disk which have been displaced to the fullest extent so that the valve is opened,

FIG. 8 schematically illustrates the upper disk and the lower disk at the neutral position;

FIG. 9 schematically illustrates the upper disk and the lower disk which have been displaced to the fullest extent so that the valve is closed;

FIG. 10 illustrates a perspective view of an upper stem according to a second embodiment of the invention;

FIG. 11 illustrates a graph describing a relationship between a length and a cross sectional area of a taper portion shown in FIG. 10;

FIG. 12 illustrates a graph describing a relationship between a length and a radius of the taper portion in FIG. 10;

FIG. 13 illustrates a plan view of an electromagnetically driven valve according to a third embodiment of the invention;

FIG. 14 illustrates a plan view of an electromagnetically driven valve according to a fourth embodiment of the invention;

FIG. 15 illustrates a side view of a stem of the electromagnetically driven valve of the fourth embodiment, for describing an inclination of the stem;

FIG. 16 illustrates a cross sectional view of an electromagnetically driven valve according to a fifth embodiment of the invention;

FIG. 17 concretely illustrates a detector coil of the electromagnetically driven valve of the fifth embodiment;

FIG. 18 illustrates a cross sectional view of an electromagnetically driven valve according to a sixth embodiment of the invention; and

FIG. 19 schematically illustrates an electromagnetically driven valve according to a seventh embodiment of the invention.

### DETAILED DESCRIPTION OF THE EXEMPLARY EMBODIMENTS

In the following description and the accompanying drawings, the present invention will be described in more detail in terms of exemplary embodiments. In the following embodiments, the same reference numerals will be assigned to the same or equivalent portions, and the description concerning the portions having the same reference numerals will be made only once.

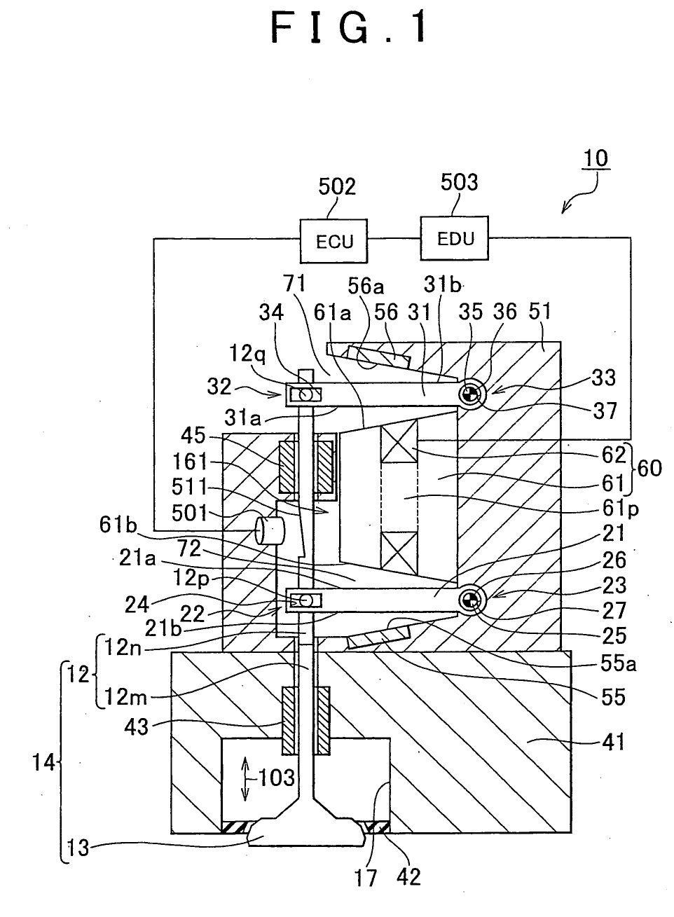

FIG. 1 illustrates a cross sectional view of an electromagnetically driven valve according to a first embodiment of the invention. The electromagnetically driven valve in the first embodiment is used as an engine valve (an intake valve or an exhaust valve) of an internal combustion engine such as a gasoline engine or a diesel engine. In the following embodiments, description will be made concerning a case where the electromagnetically driven valve is used as the intake valve. However, the same structure can be employed in a case where the electromagnetically driven valve is used as the exhaust valve.

As shown in FIG. 1, an electromagnetically driven valve 10 is a rotary drive type electromagnetically driven valve, and a parallel link mechanism is used as a movement mechanism of the electromagnetically driven valve 10. The electromagnetically driven valve 10 includes a drive valve 14 having a stem 12 extending in one direction; a lower disk 21 and an upper disk 31 which are connected to the stem 12 at different positions and which oscillate by using an electromagnetic force and an elastic force that are applied thereto; an open/close electromagnet 60 which generates the electromagnetic force (hereinafter, simply referred to as an “electromagnet 60”, where appropriate); and a lower spring 26 and an upper spring 36 each of which has the elastic force. The drive valve 14 reciprocates in the direction in which the stem 12 extends (the direction shown by an arrow 103) due to the oscillating movement of the lower disk 21 and the upper disk 31.

The drive valve 14 is provided in a cylinder head 41 in which an intake port 17 is formed. A valve seat 42 is provided at a position at which the intake port 17 of the cylinder head 41 is communicated with a combustion chamber (not shown). The drive valve 14 further includes a bell portion 13 formed at an end of the stem 12. As the drive valve 14 reciprocates, the bell portion 13 contacts the valve seat 42 or moves away from the valve seat 42, whereby the intake portion 17 is closed/opened. Namely, when the stem 12 moves upward, the drive valve 14 is moved to the valve closing position, and when the stem 12 moves downward, the drive valve 14 is moved to the valve opening position.

The stem 12 is formed of a lower stem 12m that extends from the bell portion 13, and an upper stem 12n that is connected to the lower stem 12m. A lash adjuster may be provided between the lower stem 12m and the upper stem 12n. Connection pins 12p, 12q, which protrude from the outer surface of the upper stem 12n, are provided on the upper stem 12n at a predetermined distance from each other.

A valve guide 43 is provided in the cylinder head 41 so as to slidably guide the lower stem 12m in the axial direction. A stem guide 45 is provided so as to slidably guide the upper stem 12n in the axial direction, at a position at a predetermined distance from the valve guide 43. The valve guide 43 and the stem guide 45 are made of metal material such as stainless so as to endure sliding with the stem 12 at a high speed.

A disk base 51 is provided on the cylinder head 41. The disk base 51 supports the lower disk 21 and the upper disk 31, and positions the electromagnet 60. The lower disk 21 and the upper disk 31 are movably fixed to the disk base 51. A first end 22 of the lower disk 21 is connected to the connection pin 12p, and a second end 23 of the lower disk 21 is attached to a supporting point 25 via the lower spring 26. Similarly, a first end 32 of the upper disk 31 is connected to the connection pin 12q, and a second end 33 of the upper disk 31 is attached to a supporting point 35 via the upper spring 36. The electromagnet 60 is provided between the lower disk 21 and the upper disk 31. The electromagnet 60 is formed of an open/close core 61 serving as a core body, and an open/close coil 62 wound around the open/close core 61. When an electric current is caused to pass through the open/close coil 62, a magnetic field is generated, and the lower disk 21 and the upper disk 31 are driven by using the magnetic force. The lower disk 21 has surfaces 21a, 21b, and a valve opening permanent magnet 55 is provided so as to face the surface 21b. The valve opening permanent magnet 55 has an attraction surface 55a that faces the surface 21b. A valve closing permanent magnet 56 is provided in the disk base 51 so as to face the surface 31b of the upper disk 31. An attraction surface 56a of the valve closing permanent magnet 56 faces the surface 31b of the upper disk 31. When the valve opens, the valve opening permanent magnet 55 contacts the lower disk 21. On the other hand, when the valve closes, the valve closing permanent magnet 56 contacts the upper disk 31.

A detector coil 501 for detecting the positions of the drive valve 14 and the stem 12 is provided in the disk base 51. The detector coil 501 detects a position in a taper portion 511 of the stem 12, whose cross sectional area continuously changes, thereby detecting the position of the stem 12. In the first embodiment, the detector coil 501 is provided in the disk base 51. However, the detector coil 501 may be provided in the cylinder head 41. The detector coil 501 is connected to an ECU (engine control unit) 502. The ECU 502 determines the position of the stem 12 according to a signal transmitted from the detector coil 501. This positional information is transmitted to an EDU (engine drive unit) 503. The EDU 503 decides an amount of electric current to be supplied to the open/close coil 62, and causes a predetermined amount of electric current to pass through the open/close coil 62.

In the first embodiment, the portion (the taper portion 511) whose cross sectional area changes is provided in the stem 12 which connects the lower disk 21 to the upper disk 31 that serve as two flaps. The detector coil 501 is provided on the side of the taper portion 511. The stem 12 is formed of a square rod, and the taper portion 511 whose cross sectional area linearly changes is formed in the stem 12 at a portion facing the detector coil 501. The size of the taper portion 511 may be made larger than the size of the stem body. In this case, the sensitivity of the sensor can be further improved.

It is preferable that the distance between the detector coil 501 and the taper portion 511 be shorter in order to increase the accuracy of the detection. It is, therefore, preferable that the difference in the thickness of the stem 12 before and after forming the taper portion 511 be equal to or smaller than 50 μm. Namely, it is preferable that the difference between the thickness of the taper portion 511 and the thickness of the stem 12 be equal to or smaller than 50 μm. Note that, the taper portion 511 and the detector coil 501 may be provided at the stem guide portion 45.

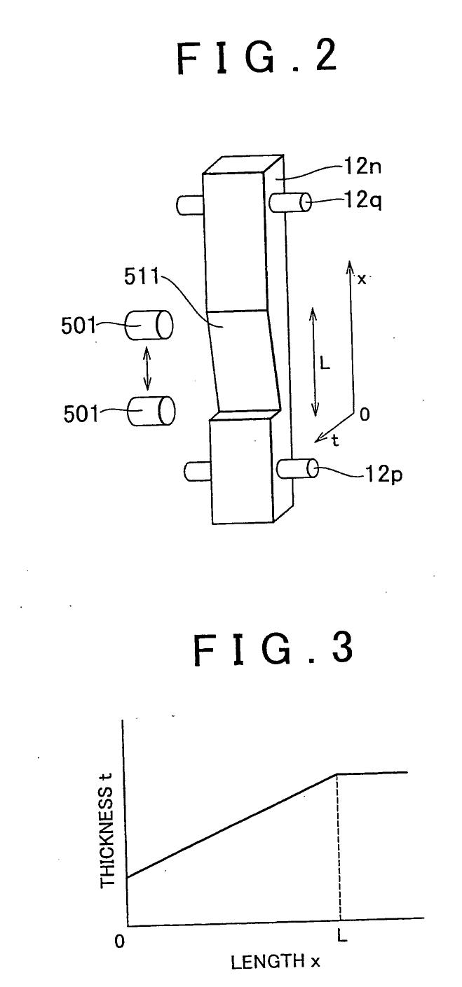

FIG. 2 concretely illustrates a perspective view of the stem. As shown in FIG. 2, the upper stem 12n has a square rod shape. A part of the stem 12n is deleted such that the stem 12n has a notched shape. The taper portion 511 is thus formed. The taper portion 511 is linearly formed. The taper portion 511 has a length of “L”, and a thickness of “t” that continuously changes. The detector coil 501 measures a lateral area of the taper portion 511 while not contacting the taper portion 511, and detects the position of the upper stem 12n based on the lateral area of the taper portion 511.

FIG. 3 illustrates a graph describing a relationship between the length “L” and the thickness “t” of the taper portion 511. As shown in FIG. 3, a portion of the upper stem 12n corresponds to the taper portion 511. In the taper portion 511, the length “x” of the upper stem 12n ranges from “0” to “L”. In the taper portion 511, the thickness “t” continuously changes. Note that, the thickness “t” of the taper portion 511 need not change linearly, as long as the thickness “t” continuously changes. In FIG. 3, the thickness “t” of the taper portion 511 may increase linearly from a lower portion toward an upper portion of the taper portion 511. Alternatively, the thickness “t” of the taper portion 511 may change such that the thickness “t” increases or decreases in a curved manner from the lower portion toward the upper portion of the taper portion 511.

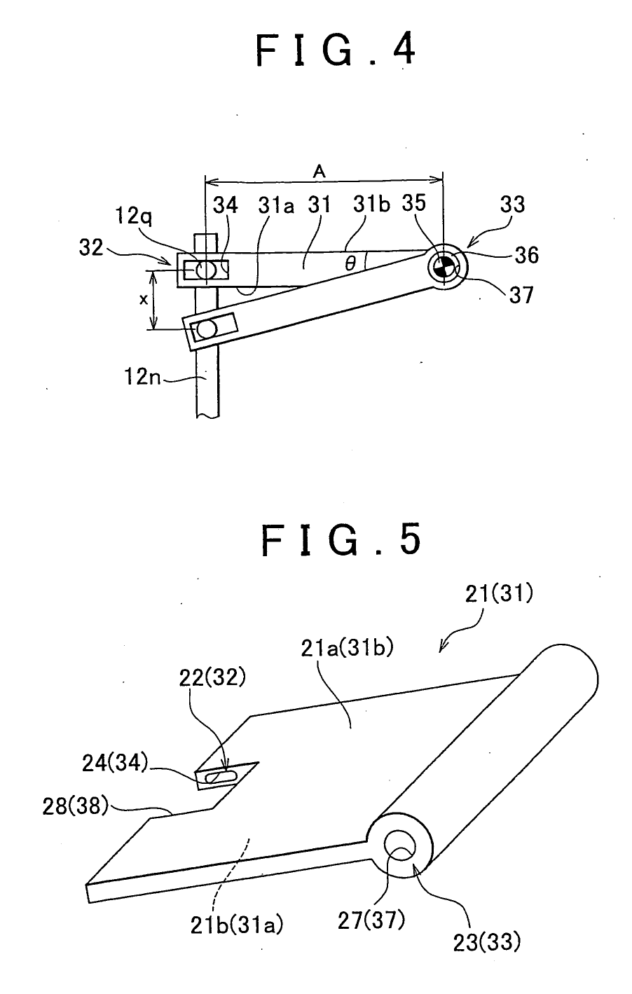

FIG. 4 illustrates a side view describing an angle formed by the upper disk 31. As shown in FIG. 4, the upper disk 31 can oscillates (tilt) from the neutral position to a position corresponding to an oscillation angle θ. When the upper disk 31 oscillates by the oscillation angle θ, an amount of displacement of the upper stem 12n is “x”. In this case, the oscillation angle θ is expressed by the following equation.

θ=tan⁻¹(x/A)

The detector coil 501 in FIG. 1 detects a lift amount “x” (refer to FIG. 4) of the upper stem 12n, and transmits the detection data to the ECU 502. The ECU 502 calculates the oscillation angle θ by using the above-mentioned equation, and the EDU 503 causes an electric current to pass through the open/close coil 62 based on the information concerning the oscillation angle θ.

FIG. 5 illustrates a perspective view of the lower disk (upper disk) in FIG. 1. As shown in FIG. 1 and FIG. 5, the lower disk 21 has the first end 22 and second end 23, and extends from the first end 22 toward second end 23 in the direction that crosses the direction in which the stem 12 extends. The lower disk 21 is formed so as to have a flat plate shaped portion having the rectangular surfaces 21a, 21b, in the first end 22 side. Also, the lower disk 21 is formed so as to have a hollow cylindrical portion in which a hole 27 is formed, in the second end 23 side. A notched portion 28 is formed in the lower disk 21 in the first end 22 side, and a long hole 24 is formed in each of wall surfaces of the notched portion 28, which face each other.

The upper disk 31 has the same structure as that of the lower disk 21. In the upper disk 31, the first end 32, second end 33, a surface, 31b, a surface 31a, a hole 37, a notched portion 38, and a long hole 34 are formed, which correspond to the first end 22, the second end 23, the surface 21a, the surface 21b, the hole 27, the notched portion 28, and the long hole 24 in the lower disk 21, respectively. The lower disk 21 and the upper disk 31 are made of a soft magnetic material.

The first end 22 of the lower disk 21 is movably connected to the upper stem 12n when the connection pin 12p is inserted into the long holes 24. Similarly, the first end 32 of the upper disk 31 is movably connected to the upper stem 12n when the connection pin 12q is inserted into the long holes 34. The disk base 51 extending in parallel with the stem 12 is provided on the top surface of the cylinder head 41. The second end of the lower disk 21 is supported by the disk base 51 such that the lower disk 21 can oscillate with respect to the supporting point 25 in the disk base 51. Similarly, the second end 33 of the upper disk 31 is supported by the disk base 51 such that the upper disk 31 can oscillate with respect to the supporting point 35 in the disk base 51. With such a structure, the drive valve 14 can be reciprocated by oscillating the lower disk 21 with respect to the supporting point 25, and the upper disk 31 with respect to the supporting point 35.

The lower spring 26 is provided in the second end 23 of the lower disk 21, and the upper spring 36 is provided in the second end 33 of the upper disk 31. The lower spring 26 applies an elastic force to the lower disk 21 in the clockwise direction around the supporting point 25. The upper spring 36 applies an elastic force to the upper disk 31 in the counterclockwise direction around the supporting point 35. In the state where an electromagnetic force is not applied by the after-mentioned electromagnet 60 (i.e., in the neutral state), the lower disk 21 and the upper disk 31 are placed at the neutral position by the lower spring 26 and the upper spring 36. The neutral position is between the position of these disks, which have been displaced to the fullest extent so that the valve is opened, and the position of these disks, which have been displaced to the fullest extent so that the valve is closed.

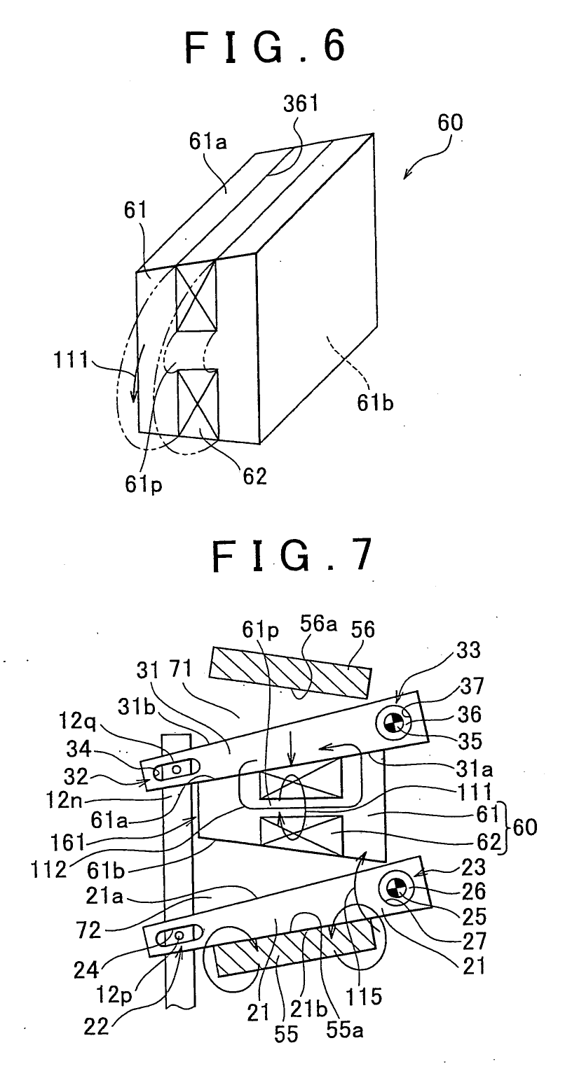

FIG. 6 illustrates a perspective view of the electromagnet 60 in FIG. 1. As shown in FIG. 1 and FIG. 6, the disk base 51 is provided with the electromagnet 60 such that the electromagnet 60 is positioned between the lower disk 21 and the upper disk 31. The electromagnet 60 includes the open/close coil 62, and the open/close core 61 which is made of a magnetic material and which has an attraction surface 61a facing the surface 31a of the upper disk 31, and an attraction surface 61b facing the surface 21a of the lower disk 21. The open/close core 61 has a shaft portion 61p that extends in a direction from the first end toward the second end of one of the lower disk 21 and the upper disk 31. The open/close coil 62 is provided so as to be wound around the shaft portion 61p. The open/close coil 62 is formed of a mono-coil.

The disk base 51 further includes the valve opening permanent magnet 55, and the valve closing permanent magnet 56 that is opposed to the valve opening permanent magnet 56 with the electromagnet 60 interposed therebetween. The valve opening permanent magnet 55 has the attraction surface 55a that faces the surface 21b of the lower disk 21. A space 72 in which the lower disk 21 oscillates is provided between the attraction surface 55a and the attraction surface 61b of the electromagnet 60. The valve closing permanent magnet 56 has the attraction surface 56a that faces the surface 31b of the upper disk 31. A space 71 in which the upper disk 31 oscillates is provided between the attraction surface 56a and the attraction surface 61a of the electromagnet 60.

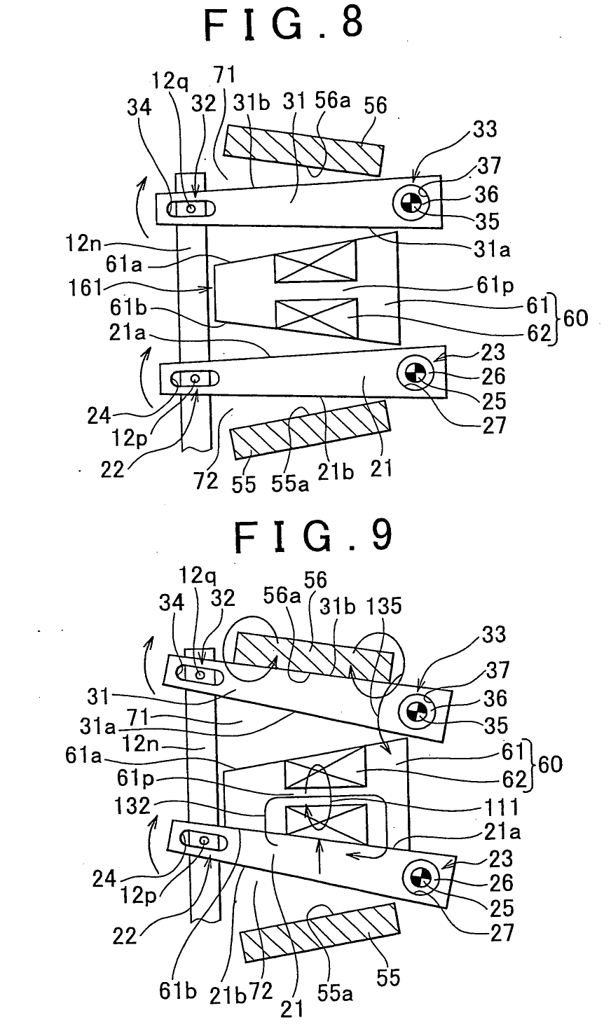

FIG. 7 schematically illustrates the upper disk 31 and the lower disk 21 which have been displaced to the fullest extent so that the valve is opened FIG. 8 schematically illustrates the upper disk 31 and the lower disk 21 at the neutral position. FIG. 9 schematically illustrates the upper disk 31 and the lower disk 21 which have been displaced to the fullest extent so that the valve is closed. The operation of the electromagnetically driven valve 10 will be described with reference to FIGS. 7, 8, and 9.

As shown in FIG. 7, when the drive valve 14 is at the valve opening position, an electric current, which flows around the shaft portion 61p of the open/close core 61 in the direction shown by an arrow 111, is supplied to the open/close coil 62. Thus, a magnetic flux flows in the open/close core 61 in a direction shown by an arrow 112, whereby an electromagnetic force for attracting the upper disk 31 to the attraction surface 61a of the electromagnet 60 is generated. Meanwhile, the lower disk 21 is attracted to the attraction surface 55a by the valve opening permanent magnet 55. As a result, as shown in FIG. 4, the upper disk 31 and the lower disk 21 are displaced to the fullest extent so that the valve is opened, and maintained in this state against the elastic force of the lower spring 26 provided around the supporting point 25.

As shown in FIG. 8, if the supply of the electric current to the open/close coil 62 is stopped, the electromagnetic force generated in the electromagnet 60 disappears. Thus, the upper disk 31 and the lower disk 21 move away from the attraction surfaces 61a, 55a, respectively, due to the elastic force of the lower spring 26, and start to oscillate toward the neutral position. The elastic force of the lower spring 26 and the upper spring 36 attempts to maintain the upper disk 31 and the lower disk 21 at the neutral position. Thus, when the upper disk 31 and the lower disk 21 oscillate and exceed the neutral position, a force is applied to the upper disk 31 and the lower disk 21 by the upper spring 36 in the direction opposite to the direction in which the upper disk 31 and the lower disk 21 oscillate. However, since an inertia force is applied to the upper disk 31 and the lower disk 21 in the direction in which the upper disk 31 and the lower disk 21 oscillate, the upper disk 31 and the lower disk 21 oscillate and exceed the neutral position.

As shown in FIG. 9, an electric current is applied to the open/close coil 62 again in the direction shown by the arrow 111, when the upper disk 31 and the lower disk 21 exceed the neutral position in the upward direction. Thus, a magnetic flux is applied to the open/close core 61 in the direction shown by an arrow 132, whereby an electromagnetic force for attracting the lower disk 21 to the attraction surface 61b of the electromagnet 60 is generated. Meanwhile, the upper disk 31 is attracted to the attraction surface 56a by the valve closing permanent magnet 56.

Also, the upper disk 31 is attracted to the attraction surface 61a of the electromagnet 60 due to an electromagnetic force generated in the electromagnet 60. However, the electromagnetic force acts more strongly as the distance between the lower disk 21 and the electromagnet 60 becomes shorter. Accordingly, the upper disk 31 and the lower disk 21 oscillate from the position above the neutral position, and are displaced to the fullest extent so that the valve is closed, as shown in FIG. 9

Then, the supply of the electric current to the open/close coil 62 is repeatedly started and stopped at the above-mentioned timing. The upper disk 31 and the lower disk 21 are oscillated so as to be repeatedly displaced to the fullest extent so that the valve is opened and displaced to the fullest extent so that the valve is closed. The drive valve 14 can be reciprocated due to this oscillating movement.

During this reciprocating movement, the detector coil 501 shown in FIG. 1 detects a position in the taper portion 511, that is, the position of the stem 12. The detected positional information is transmitted to the ECU 502, and the ECU 502 transmits the appropriate information to the EDU 503. As a result, the EDU 503 supplies a required amount of electric current to the open/close coil 62. Thus, the required amount of electric current can be reliably supplied to the open/close coil 62.

The thus configured electromagnetic valve 10 according to the first embodiment is an electromagnetically driven valve that operates by using both an electromagnetic force and an elastic force. The electromagnetically driven valve 10 includes the drive valve 14 that includes the stem 12 serving as a valve stem and that reciprocates in the direction in which the stem 12 extends; the lower disk 21 and the upper disk 31 each of which can oscillate by using a predetermined point in the disk base 51 as a supporting point, each of which is movably connected to the stem 12 at the first end 22 (32) and is movably supported by the disk base 51 at the second end 23 (33), and which are provided at a predetermined distance from each other, the electromagnet 60 which includes the open/close coil 62, and which is provided between the lower disk 21 and the upper disk 31; and the detector coil 501 which detects the position of at least one of the drive valve 14, the lower disk 21, and the upper disk 31. An electromagnetic force is applied to the lower disk 21 and the upper disk 31, when an electric current passes through the open/close coil 62. An amount of electric current to be supplied to the open/close coil 62 is determined based on the position of the drive valve 14 detected by the detector coil 501. The cross sectional area of the taper portion 511, which is a part of the drive valve 14, continuously changes, and the detector coil 501 detects the position of the drive valve 14 based on the position in the taper portion 511.

In the thus configured electromagnetic valve 10 according to the first embodiment, since the position of the stem 12 is detected by the detector coil 501, the entire height of the electromagnetically driven valve 10 can be made low. In addition, since the detector coil 501 is provided on the side of the stem 12, the electromagnetically driven valve 10 is excellent in assembling performance, adjustability, and maintenance performance (exchangeability). Also, a gap sensor, which has a simple structure and which is used most commonly, can be used as a non-contact displacement sensor. Accordingly, cost performance, noise resistance, environment resistance, and durability of the electromagnetically driven valve 10 can be improved.

In addition, since the detector coil 501 serving as a lift sensor can be provided on the side of the electromagnet 60, the detector coil 501 is not easily affected by the magnetic flux that leaks from the electromagnet 60, and an error (noise) in the lift amount detection is reduced. Accordingly, the time in which electric power is supplied the electromagnetically driven valve 10 (actuator) is controlled more effectively. As a result, operating stability can be improved, a speed at which the valve contacts the valve seat can be reduced, and electric power consumption can be reduced.

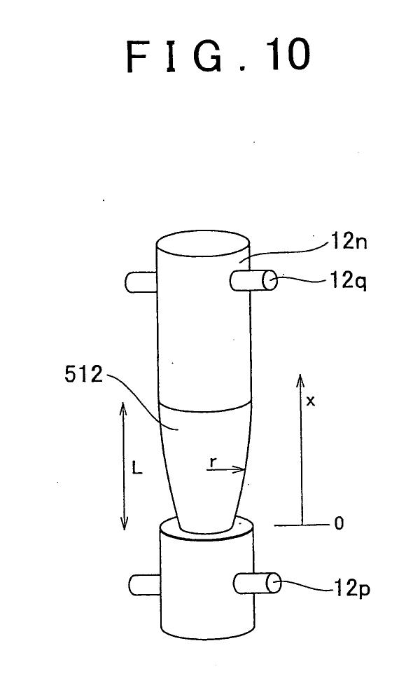

Next, a second embodiment of the invention will be described. FIG. 10 illustrates a perspective view of the upper stem 12n according to the second embodiment of the invention. As shown in FIG. 10, the main body of the upper stem 12n according to the second embodiment of the invention is formed in a cylindrical shape. The detector coil 501 shown in FIG. 1 faces a taper portion 512. When the radius of an arbitrary portion of the taper portion 512 is “r”, and the distance between the thinnest portion in the taper portion 512 and the arbitrary portion in the taper portion 512 is “x”, the radius “r” is expressed by the following equation.

r={(ax+b)/π}^{1/2}

Here, “a” and “b” in the above equation are determined based on the output characteristics of the sensor and the rigidity of the upper stem 12n. The length “L” of the taper portion 512 is equal to or longer than a value obtained by the following equation.

“stroke of upper stem 12n+2×diameter of detector coil 501”

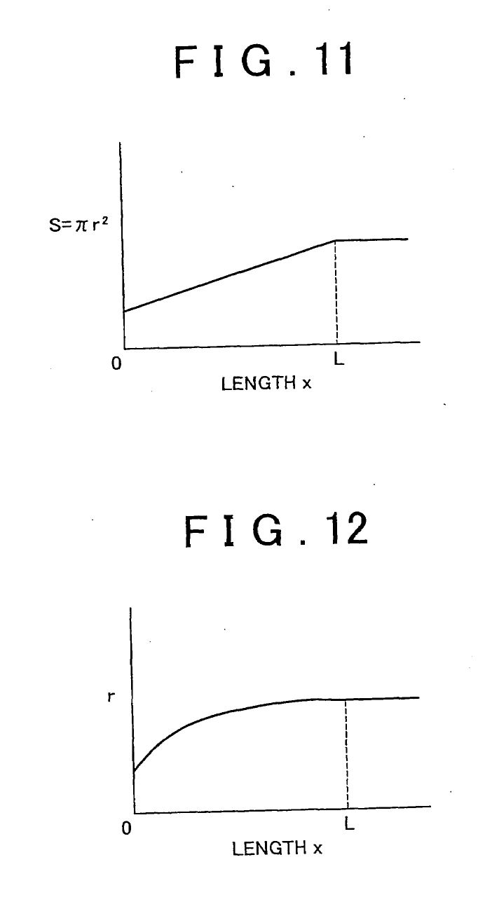

FIG. 11 illustrates a graph describing a relationship between the length and the cross sectional area of the taper portion 512 shown in FIG. 10. FIG. 12 illustrates a graph describing the relationship between the length and the radius of the taper portion 512 in FIG. 10. As shown in FIGS. 11 and 12, the cross sectional area of the taper portion 512 linearly increases from one end to the other end of the taper portion 512. Namely, the linearity of the output from the sensor is improved. As a result, the accuracy of the control of electric power supplied to the electromagnetically driven valve 10 can be improved.

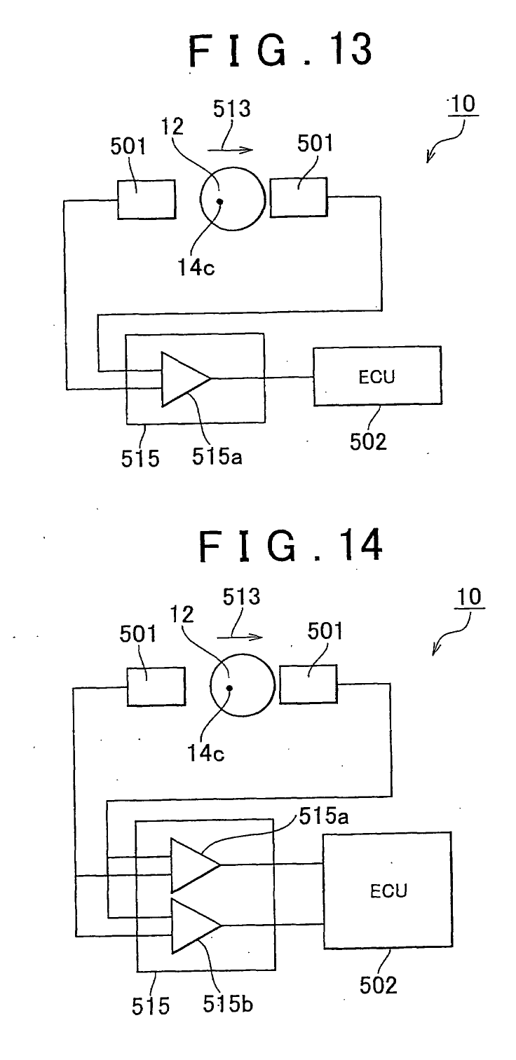

Next, a third embodiment of the invention will be described. FIG. 13 illustrates a plan view of the electromagnetically driven valve 10 according to the third embodiment of the invention. As shown in FIG. 13, the electromagnetically driven valve 10 according to the third embodiment is different from the electromagnetically driven valve 10 according to the first embodiment in that a deviation of the stem 12 from the reference axis is detected by paired detector coils 501. More specifically, the deviation of the central axis of the stem 12 from a reference axis 14c serving as the central axis of the drive valve is measured by using the two detector coils 501 and a sense amplifier 515 connected to these detector coils 501. An adder 515a is provided in the sense amplifier 515, and the adder 515a is connected to the ECU 502. In FIG. 13, the stem 12 is deviated from the reference axis 14c in the direction shown by an arrow 513. The detector coils 501 are provided so as to be opposed to each other with the stem 12 interposed therebetween. The adder 515a adds up the outputs from the detector coils 501 opposed to each other, thereby obtaining the final output. The number of pairs of the detector coils 501 opposed to each other may be equal to or larger than two. In this case as well, the outputs, each of which is obtained by adding up the outputs from the paired two detector coils 501, are added up, whereby the final output is obtained.

The electromagnetically driven valve 10 according to the third embodiment detects the deviation of the stem 12, which serves as a valve stem that is a part of the drive valve, with respect to the reference axis 14c.

With the thus configured electromagnetically driven valve 10 according to the third embodiment, an accurate output can be obtained even if there is a deviation of the stem 12 from the reference axis due to inclination or the like.

Also, since the number of the detector coils is increased, the signal noise (S/N) ratio is increased. Accordingly, the accuracy of the control of electric power supply to the electromagnetically driven valve 10 is improved. As a result, operating stability can be improved, a speed at which the valve contacts the valve seat can be reduced, and electric power consumption can be reduced.

Next, a fourth embodiment of the invention will be described. FIG. 14 illustrates a plan view of the electromagnetically driven valve 10 according to the fourth embodiment As shown in FIG. 14, the electromagnetically driven valve 10 according to the fourth embodiment is different from the electromagnetically driven valve 10 according to the third embodiment in that there is provided a subtracter 515b which outputs a difference between the outputs from the detector coils 501 opposed to each other. The subtracter 515b obtains the difference between the data detected by the two detector coils 501, and transmits a signal indicating the difference to the ECU 502. The ECU 502 calculates an eccentricity of the stem 12 with respect to the detector coils 501 based on the signal indicating the difference, and calculates an inclination angle θ of the stem 12 with the positions of the detector coils 501 taken into account.

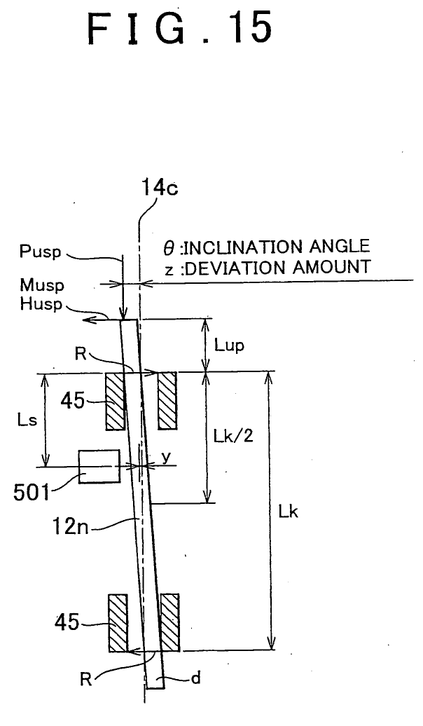

FIG. 15 illustrates a side view of the stem, which is used for describing the inclination of the stem 12. A resistance R applied to the stem guide 45 serving as a bearing is calculates based on the inclination angle θ by using an approximate expression obtained based on a balance of moment at the end portion of the stem guide 45. Thus, a sliding resistance F applied to the bearing is calculated. Note that, the inclination angle θ, a deviation amount “z”, the resistance R and the sliding resistance F are calculated by the following equations.

$$θ = \frac{y}{Lk / 2 - Ls} \\ z = θ \times ( Lup + Lk / 2 ) \\ R \approx \frac{1}{Lk} \{ Pusp \times ( d / 2 + z ) + Musp + Husp \times ( Lk + Lup ) \} \\ F = μ \times R \\ Note \text{:} “ μ ” indicates coefficient of dynamic friction \qquad Equations 1$$

Model equation used for control of electric power supplied to the electromagnetically driven valve

$$\frac{{d}^{2} x}{d {t}^{2}} = - \frac{C}{M} \frac{d x}{d t} - \frac{K}{M} x + \frac{1}{M} u + \frac{1}{M} F$$

$$Note \text{:} “ u ” indicates electromagnetic force$$

The thus obtained sliding resistance F is applied to the model equation used for the control of electric power supplied to the electromagnetically driven valve 10, whereby the accuracy of the control can be considerably increased.

A deviation “y” of the axis, a distance Lk between the bearings, a distance Lup between the upper end of the upper bearing and the upper end portion of the stem, a load Pusp of the upper spring, a diameter “d” of the stem, the deviation amount “z”, a moment Mysp of the upper spring, and a lateral force Husp of the upper spring are shown in FIG. 15.

With the thus configured electromagnetically driven valve 10, the sliding resistance F can be measured in real time. The sliding resistance F changes according to a lift amount. Therefore, the accuracy of control can be considerably improved by applying the measured sliding resistance F to a part corresponding to the sliding resistance in the model equation used for the control of electric power supplied to the electromagnetically driven valve 10. As a result, operating stability can be improved, a speed at which the valve contacts the valve seat can be reduced, and electric power consumption can be reduced.

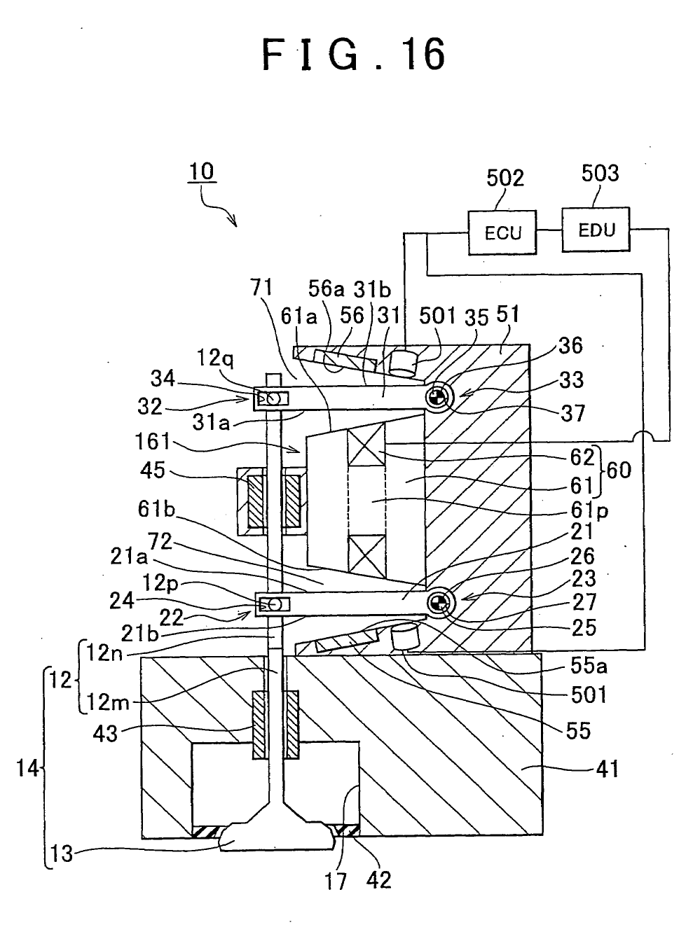

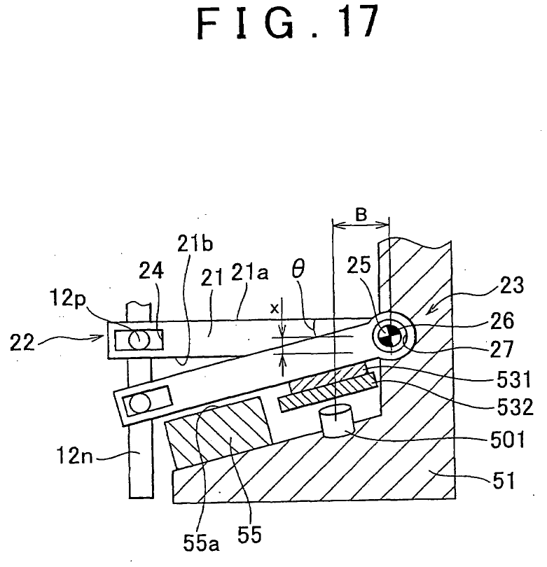

Next, a fifth embodiment of the invention will be described. FIG. 16 schematically illustrates the electromagnetically driven valve 10 according to the fifth embodiment. As shown in FIG. 16, the electromagnetically driven valve 10 according to the fifth embodiment is different from the electromagnetically driven valve 10 according to the first embodiment in that the detector coils 501 are provided such that one of the detector coils 501 faces the lower disk 21 and the other detector coil 501 faces the upper disk 31. Namely, one of the detector coils 501 is arranged below the lower disk 21 serving as a lower flap, and the other detector coil 501 is arranged above the upper disk 31 serving as an upper flap. Both of the detector coils 501 are provided in the disk base 51. The lower disk 21 and the upper disk 31 themselves, that are a part of an operating portion, are used as members subjected to the detection.

FIG. 17 concretely illustrates the detector coil 501. As shown in FIG. 17, a spacer 531 made of a nonmagnetic material is attached to the lower disk 21, and a disk 532 made of a magnetic material is provided so as to contact the spacer 531. Providing the spacer 531 made of the nonmagnetic material makes it possible to magnetically separate the lower disk 21 and the disk 532 from the each other, and to prevent the magnetic flux generated by the electromagnet 60 from affecting the detector coil 501. Thus, an erroneous operation can be prevented in advance.

The detector coil 501 detects a lift amount “x” of the lower disk 21. The oscillation angle θ of each of the lower disk 21 and the upper disk 31 serving as armature disks is calculated based on the detected lift amount “x”. The calculation is performed by using the following equation.

θ=tan⁻¹(x/B)

“B” in the above equation is a distance from the supporting point 25 to the detector coil 501.

The amount of electric current to be supplied to the open/close coil 62 is controlled based on the thus obtained oscillation angle θ.

The positional relationship between the valve opening permanent magnet 55 and the valve closing permanent magnet 56, and the detector coils 501 may be different from the positional relationship shown in FIGS. 16 and 17. Namely, in FIGS. 16 and 17, the distance between the valve opening permanent magnet 55 and the supporting point 25 is longer than the distance between the detector coil 501 and the supporting point 25, and the distance between the valve closing permanent magnet 56 and the supporting point 35 is longer than the distance between the detector coil 501 and the supporting point 35. However, the distance between the valve opening permanent magnet 55 and the supporting point 25 may be shorter than the distance between the detector coil 501 and the supporting point 25, and the distance between the valve closing permanent magnet 56 and the supporting point 35 may be shorter than the distance between the detector coil 501 and the supporting point 35. In this case, since the detector coils 501 serving as the sensors are provided at the positions distant from the supporting points 25, 35, the accuracy of detection is improved.

With the thus configured electromagnetically driven valve 10 according to the fifth embodiment, a lift sensor need not be provided immediately above or immediately below the electromagnetically driven valve 10, and the entire height of the electromagnetically driven valve 10 can be made low.

Since the detector coil 501 is provided so as to face the upper disk 31, the electromagnetically driven valve 10 is excellent in assembling performance, adjustability, and maintenance performance (exchangeability). In the fifth embodiment, the two detector coils 501 are used in order to detect the movement of both the lower disk 21 and the upper disk 31. However, the number of the detector coils 501 is not limited to two. For example, only a detector coil for detecting an operation of the lower disk 21 may be provided, or only a detector coil for detecting an operation of the upper disk 31 may be provided.

In addition, since the lower disk 21 and the upper disk 31 themselves are used as members subjected to the detection, assembling performance is excellent, and the number of the components can be made small. As a result, a production cost can be suppressed.

Further, a gap sensor, which has a simple structure and which is used most commonly, can be used as the non-contact displacement sensor. Accordingly, the electromagnetically driven valve 10 is excellent in cost performance, noise resistance, environment resistance, and durability.

In addition, since a taper need not be formed in the stem 12, the rigidity of the stem 12 can be improved, and, therefore, durability thereof can be improved. When the taper is provided, the rigidity of the stem is reduced. Accordingly, the size and the weight of the stem 12 are increased in order to compensate the decrease in the rigidity. In contrast to this, according to the invention, the weight of the stem 12 can be reduced, and the weight of the operating member can be reduced. Accordingly, electric power consumption can be reduced, and the performance of the engine can be improved.

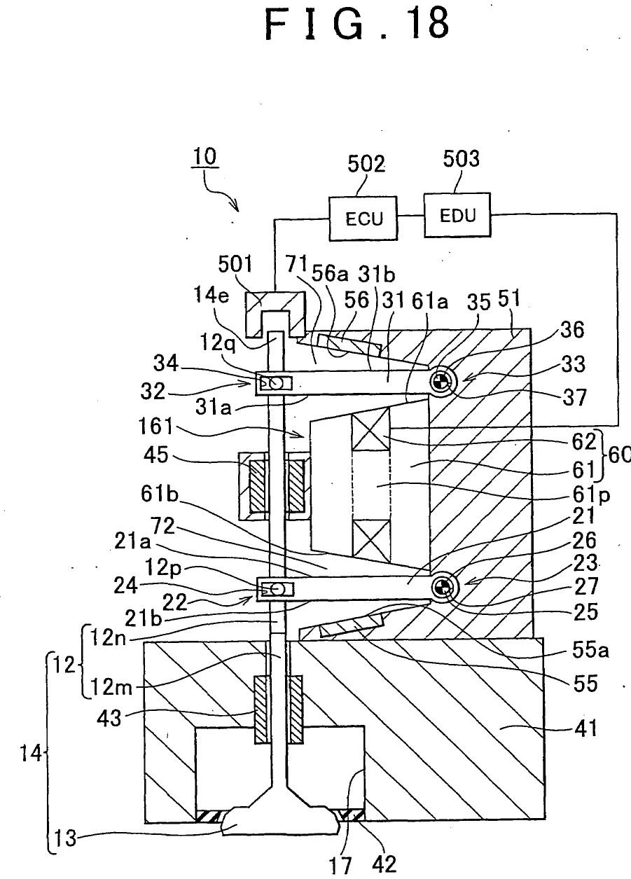

Next, a sixth embodiment of the invention will be described. FIG. 18 schematically illustrates the electromagnetically driven valve 10 according to the sixth embodiment. As shown in FIG. 18, the electromagnetically driven valve 10 according to the sixth embodiment is different from the electromagnetically driven valve 10 according to the first embodiment in that the detector coil 501 is provided so as to face an upper end portion 14e of the drive valve 14. The upper end portion 14e of the drive valve 14, namely, the end portion itself of the upper stem 12n is used as a member subjected to the detection performed by the detector coil 501. The detector coil 501 detects a lift amount “x”, and obtains an oscillation angle θ of each of the lower disk 21 and the upper disk 31 based on the lift amount “x”. The oscillation angle θ is calculated by the following equation.

θ=tan⁻¹(x/A)

“A” in the above equation is equal to the length “A” of the upper disk 31 in FIG. 4. The ECU 502 transmits a signal based on the angle θ to the EDU 503. The EDU 503 decides an amount of electric current to be supplied to the open/close coil 62 according to the signal.

In the thus configured electromagnetically driven valve 10 according to the sixth embodiment, the stem 12 itself is used as the member subjected to the detection performed by the detector coil 501. Accordingly, assembling performance is excellent, and the number of the components can be made small. As a result, a production cost can be suppressed.

Also, it is not necessary to prepare an extra component as a member subjected to the detection. Therefore, a connecting portion for the member need not be provided. As a result, the entire height of the electromagnetically driven valve 10 can be made low.

With this structure, the weight of the stem 12 can be reduced, and the weight of the operating portion can be reduced. As a result, a reduction in electric power consumption and an increase in the engine performance can be expected.

In addition, the rigidity of the member subjected to the detection, which is formed in the stem 12, can be improved. As a result, durability of the sensor and the actuator assy can be improved.

Also, assembling performance, adjustability, and maintenance performance (exchangeability) of the detector coil 501 are excellent.

In addition, the detector coil 501 formed of a sensor coil can be provided at a predetermined distance from the electromagnet 60. Accordingly, the detector coil 501 is not easily affected by the magnetic flux that vertically leaks from the electromagnet 60. Therefore, an error (noise) in the lift amount detection is reduced, and therefore, the accuracy of the control of electric power supplied to the electromagnetically driven valve 10 is improved. As a result, operating stability can be improved, a speed at which the valve contacts the valve seat can be reduced, and electric power consumption can be reduced.

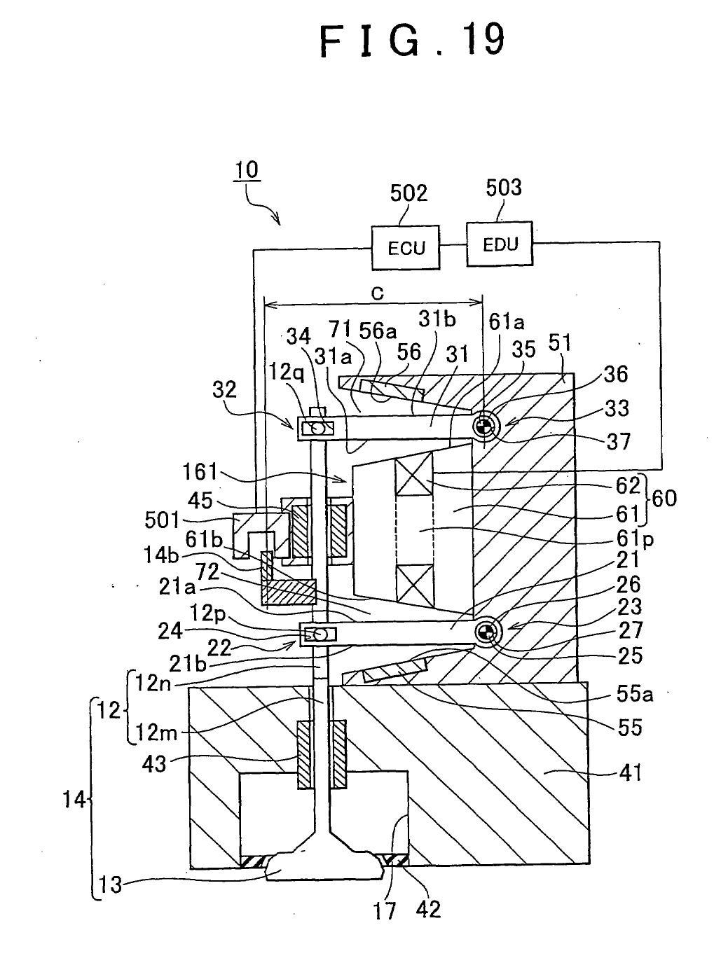

Next, a seventh embodiment of the invention will be described. FIG. 19 schematically illustrates the electromagnetically driven valve 10 according to the seventh embodiment As shown in FIG. 19, in the electromagnetically driven valve 10 according to the seventh embodiment, the detector coil 501 is provided on the side of the stem 12. More specifically, a branch portion 14b extending from the stem 12 is provided, and the detector coil 501 detects a stroke of the branch portion 14b.

A distance from the branch portion 14b to the supporting point 35 is “C”. The branch portion 14b itself may serve as a sensor core. The oscillation angle θ of each of the lower disk 21 and the upper disk 31 is calculated based on the lift amount “x” of the stem 12 detected by the detector coil 501. The calculation is performed by using the following equation.

θ=tan⁻¹(x/C)

The data concerning the oscillation angle θ is transmitted to the ECU 502, and the ECU 502 sets a current value indicating an amount of electric current to be supplied to the open/close coil 62. The current value is transmitted to the EDU 503, and a predetermined amount of electric current is supplied to the open/close coil 62 by the EDU 503.

In the thus configured electromagnetically driven valve 10 according to the seventh embodiment, assembling performance, adjustability, and maintenance performance (exchangeability) of the detector coil 501 are excellent.

In addition, the lift amount sensor need not be provided immediately above or immediately below the electromagnetically driven valve 10. As a result, the entire height of the electromagnetically driven valve 10 can be made low.

The detector coil 501 serving as a lift amount sensor can be provided on the side of the electromagnet 60. Accordingly, the detector coil 501 is not easily affected by the magnetic flux that vertically leaks from the electromagnet 60, and an error (noise) in the lift amount detection is reduced. Therefore, the accuracy of the control of electric power supplied to the electromagnetically driven valve 10 is improved. As a result, operating stability can be improved, a speed at which the valve contacts the valve seat can be reduced, and electric power consumption can be reduced.

Also, the detector coil 501 can be provided at a position at a predetermined distance from the electromagnet 60. Accordingly, the detector coil 501 is not easily affected by the magnetic flux that vertically leaks from the electromagnet 60, and an error (noise) in the lift amount detection can be reduced.

While the invention has been described in detail with reference to the exemplary embodiments, the invention is not limited to the above-mentioned embodiments. and can be realized in various other embodiments. For example, the coil forming the open/close coil 62 is not limited to a mono-coil. Instead of the mono-coil, multiple coils may be used. Namely, the open/close coil 62 may be provided such that multiple magnetic circuits are formed.

Also, in the above-mentioned embodiments, the data obtained by the detector coil 501 is transmitted to the ECU 502. However, the data obtained by the detector coil 501 may be transmitted to another computing unit, and this computing unit may decide an amount of electric current to be supplied to the open/close coil.

The embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

The invention can be used in a technological field concerning an electromagnetically driven valve mounted in a vehicle.

1. An electromagnetically driven valve which operates by using both an electromagnetic force and an elastic force, comprising:
a drive valve that is provided with a valve stem and that reciprocates in a direction in which the valve stem extends;
a first oscillating member and a second oscillating member each of which can oscillate by using a predetermined point in a base member as a supporting point, each of which is movably connected to the valve stem at a first end and is movably supported by the base member at a second end, and which are provided at a predetermined distance from each other;
an electromagnet which includes a coil, and which is provided between the first oscillating member and the second oscillating member; and
a detection portion which detects a position of at least one of the drive valve, the first oscillating member, and the second oscillating member, wherein
the electromagnetic force is applied to the first oscillating member and the second oscillating member when an electric current passes through the coil, and
an amount of electric current that passes through the coil is determined based on the position detected by the detection portion.

2. The electromagnetically driven valve according to claim 1, wherein
a cross-sectional area of a portion in the drive valve continuously changes in the direction in which the valve stem extends, and the detection portion detects the position of the drive valve based on a position in the portion whose cross-sectional area continuously changes.

3. The electromagnetically driven valve according to claim 2, wherein
a cross-section of the portion in the drive valve, whose cross-sectional area continuously changes, is rectangular, and the cross-sectional area changes linearly in an axial direction of the valve stem.

4. The electromagnetically driven valve according to claim 2, wherein
a cross-section of the portion in the drive valve, whose cross-sectional area continuously changes, is circular, and the cross-sectional area changes linearly in an axial direction of the valve stem.

5. The electromagnetically driven valve according to claim 1, wherein
the detection portion detects a deviation of the drive valve from a reference axis.

6. The electromagnetically driven valve according to claim 5, wherein
paired detection portions are provided with the valve stem interposed between the paired detection portions in a direction perpendicular to an axial direction of the valve stem.

7. The electromagnetically driven valve according to claim 1, wherein
the detection portion is provided at an upper end portion of the drive valve.

8. The electromagnetically driven valve according to claim 1, wherein
the detection portion is provided in the base member so as to face at least one of the first oscillating member and the second oscillating member.

9. The electromagnetically driven valve according to claim 1, wherein,
if a direction in which the electric current passes through the coil is reversed in a state where one of the first oscillating member and the second oscillating member has been attracted to the electromagnet, the electromagnetic force is applied to the one of the first oscillating member and the second oscillating member, which has been attracted to the electromagnet, in a direction in which the one of the first oscillating member and the second oscillating member moves away from the electromagnet.
